(19) United States
(12) Patent Application Publication
(10) Pub. No.: US 2024/0255666 A1
(43) Pub. Date: Aug. 1, 2024

(54) LINEAR-RADON-MARCHENKO EQUATION BASED INTERNAL MULTIPLE ELIMINATION

(71) Applicant: SAUDI ARABIAN OIL COMPANY, Dhahran (SA)

(72) Inventor: Marcin Szymon Dukalski, Delft (NL)

(73) Assignee: ARAMCO OVERSEAS COMPANY B.V., The Hague (NL)

(21) Appl. No.: 18/160,902

(22) Filed: Jan. 27, 2023

(51) Int. Cl. G01V 1/34; E21B 44/00; E21B 49/00; G01V 1/36

(52) U.S. Cl. CPC G01V 1/345; G01V 1/36; E21B 7/04; G01V 2210/32; G01V 2210/74

(57) ABSTRACT

A system and method are disclosed for determining an internal multiples-free seismic dataset. The method includes obtaining a seismic dataset, wherein the seismic dataset comprises a plurality of space-time gathers, determining a first truncation operator, wherein the first truncation operator mutes samples of each trace after a first predetermined intercept time in a transform domain, and determining a second truncation operator, wherein the second truncation operator mutes samples of each trace before a second predetermined intercept time in the transform domain. The method further includes applying Marchenko internal multiple attenuation on the seismic dataset using the first and second truncation operators to determine the internal multiples-free seismic dataset.

### BACKGROUND

In the oil and gas industry, seismic surveys are frequently used to image the subsurface of the earth and the resulting seismic images may be used in the search for hydrocarbon reservoirs. Raw seismic data is of limited value and typically seismic data must be processed to form an image of the subsurface. Seismic processing methods frequently assumes seismic data is composed of seismic waves that have propagated down into the subsurface from the seismic source, at or near the surface of the earth, have been reflected once from a seismic reflector, and have propagated back to the surface of the earth where they are detected and recorded. Seismic waves that have been reflected once from a seismic reflector are often called “primary reflections” or simply “primaries”.

However, in addition to primaries, seismic data frequently includes seismic waves that have been reflected multiple times. In particular, seismic data may include seismic waves that have been reflected upward from a first seismic reflector, then reflected downward from a second seismic reflector located at a shallower depth than the first seismic reflector, and then reflected upward from a third seismic reflector at a deeper depth than the second seismic reflector. Signals of this type are termed “multiple reflections” or simply “multiples”. When seismic data containing multiples are processed under the erroneous assumption that they contain only primaries, fictious reflectors may appear in the resulting seismic image. Alternatively, real seismic reflectors may be masked or blurred in the seismic image as a result of the multiples in the seismic data. Consequently, it is desirable to have seismic processing methods capable of identifying, attenuating, or eliminating multiples.

Multiples may be divided into two groups: “surface multiples” are generated when the second (shallower) seismic reflector is the surface of the earth, while “internal multiples” are generated when the second seismic reflector is located below the surface of the earth. It is well known to practitioners of ordinary skill in the art that internal multiple attenuation and elimination may present a greater challenge than surface multiple attenuation and elimination.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to method are disclosed for determining an internal multiples-free seismic dataset. The method includes obtaining a seismic dataset, wherein the seismic dataset comprises a plurality of space-time gathers, determining a first truncation operator, wherein the first truncation operator mutes samples of each trace after a first predetermined intercept time in a transform domain, and determining a second truncation operator, wherein the second truncation operator mutes samples of each trace before a second predetermined intercept time in the transform domain. The method further includes applying Marchenko internal multiple attenuation on the seismic dataset using the first and second truncation operators to determine the internal multiples-free seismic dataset.

In one aspect, embodiments disclosed herein relate to non-transitory computer readable memory having computer-executable instructions stored thereon that, when executed by a processor, perform steps of obtaining a seismic dataset, wherein the seismic dataset comprises a plurality of space-time gathers, determining a first truncation operator, wherein the first truncation operator mutes samples of each trace after a first predetermined intercept time in a transform domain, and determining a second truncation operator, wherein the second truncation operator mutes samples of each trace before a second predetermined intercept time in the transform domain. The steps further include applying Marchenko internal multiple attenuation on the seismic dataset using the first and second truncation operators to determine an internal multiples-free seismic dataset.

In one aspect, embodiments disclosed herein relate to system, including a seismic acquisition system configured to obtain a seismic dataset, wherein the seismic dataset comprises a plurality of space-time gathers, and a seismic processing system. The seismic processing system is configured to determine a first truncation operator, wherein the first truncation operator mutes samples of each trace after a first predetermined intercept time in a transform domain, and determine a second truncation operator, wherein the second truncation operator mutes samples of each trace before a second predetermined intercept time in the transform domain. The seismic processing system is further configured to apply Marchenko internal multiple attenuation to the seismic dataset using the first and second truncation operators to determine an internal multiples-free seismic dataset.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility. Further, unless explicitly specified, the particular shapes of the elements as drawn are not necessarily intended to convey any information regarding the actual shape of the particular elements and have been solely selected for ease of recognition in the drawing.

FIG. 1 depicts a seismic survey acquisition system and seismic wave propagation, in accordance with one or more embodiments.

FIG. 2A depicts a seismic acquisition geometry and a space-time gather, in accordance with one or more embodiments.

FIG. 2B depicts a seismic acquisition geometry and a space-time gather, in accordance with one or more embodiments.

FIG. 3 illustrates aspects of Radon transforms, in accordance with one or more embodiments.

FIGS. 4A and 4B depict internal multiples, in accordance with one or more embodiments.

FIG. 5 shows a flowchart illustrating a workflow, in accordance with one or more embodiments.

FIG. 6 depicts a synthetic seismic model, in accordance with one or more embodiments.

FIGS. 7A-7G depict seismic gathers, in accordance with one or more embodiments.

FIGS. 8A-8C depicts seismic gathers, in accordance with one or more embodiments.

FIG. 9 depicts systems, in accordance with one or more embodiments.

FIG. 10 depicts a drilling system gathers, in accordance with one or more embodiments.

FIG. 11 depicts a computer system, in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to an “internal multiple” includes reference to one or more of such internal multiples.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the method may be omitted, repeated, and/or performed in a different order than the order shown. Accordingly, the scope disclosed herein should not be considered limited to the specific arrangement of steps shown in the method.

Although multiple dependent claims are not introduced, it would be apparent to one of ordinary skill that the subject matter of the dependent claims of one or more embodiments may be combined with other dependent claims.

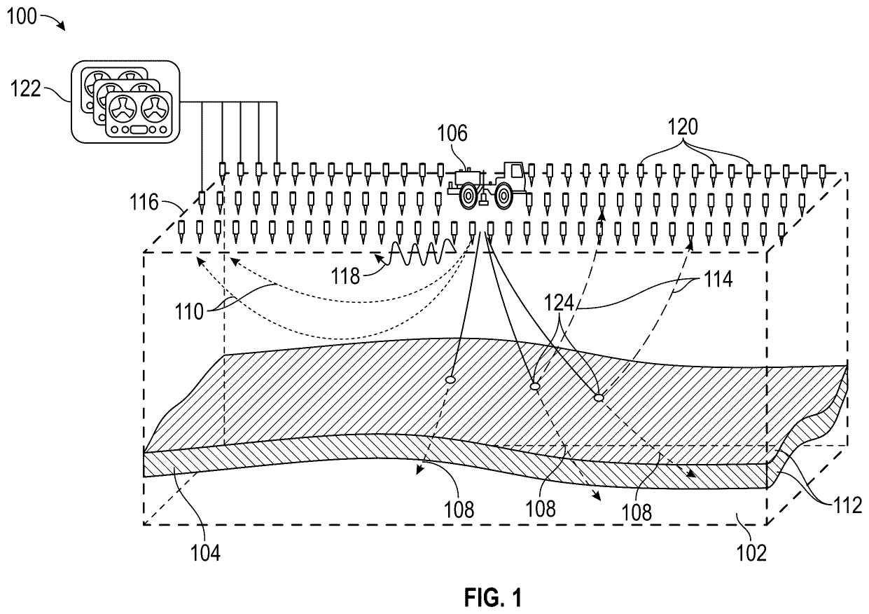

In the following description of FIGS. 1-11, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Seismic surveys are frequently conducted by participants in the oil and gas industry. Seismic surveys are conducted, using seismic acquisition systems, over subsurface regions of interest during the search for, and characterization of, hydrocarbon reservoirs. In seismic surveys, a seismic source generates seismic waves that propagate through the subterranean region of interest and are detected by seismic receivers. The seismic receivers detect and store a time-series of samples of earth motion caused by the seismic waves. The collection of time-series of samples recorded at many receiver locations generated by a seismic source at many source locations constitutes a seismic data set.

The terms “velocity model,” or other similar terms as used herein refer to a numerical representation of parameters for subsurface regions. Generally, the numerical representation includes an array of numbers, typically a 2-D or 3-D array, where each number, which may be a value of seismic wave propagation velocity in a cell, where a subsurface region has been conceptually divided into discrete cells for computational purposes. For example, the spatial distribution of velocity may be modeled using constant-velocity units (layers) through which is ray paths obeying Snell's law can be traced.

A velocity model represents the seismic velocity or the speed with which a seismic wave propagates through a subsurface material. Different subsurface materials may exhibit different seismic velocities. A velocity model may be determined from a seismic dataset using a variety of methods, known to a person of ordinary skill in the art, collectively called “velocity analysis” or “migration velocity analysis (MVA)”.

FIG. 1 shows a seismic acquisition system (100) configured to acquiring a seismic dataset pertaining to a subterranean region of interest (102). The subterranean region of interest (102) may or may not contain a hydrocarbon reservoir (104). The purpose of the seismic survey may be to determine whether or not a hydrocarbon reservoir (104) is present within the subterranean region of interest (102).

The seismic acquisition seismic (100) may utilize a seismic source (106) positioned on the surface of the earth (116). On land the seismic source (106) is typically a vibroseis truck (as shown), or less commonly explosive charges, such as dynamite, buried to a shallow depth. In water, particularly in the ocean, the seismic source may commonly be an airgun (not shown) that releases a pulse of high-pressure gas when activated. Whatever its mechanical design, the seismic source (106) generates radiated seismic waves, such as those whose paths are indicated by the rays (108). The radiated seismic waves may be bent (“refracted”) by variations in the speed of seismic wave propagation within the subterranean region (102) return to the surface (116) as refracted seismic waves (110). Alternatively, radiated seismic waves may be partially or wholly reflected by seismic reflectors and return to the surface as reflected seismic waves (114). Seismic reflectors may be indicative of the geological boundaries (112), such as the boundaries between geological layers, the boundaries between different pore fluids, faults, fractures or groups of fractures within the rock, or other structures of interest in the seismic for hydrocarbon reservoirs.

At the surface, the refracted seismic waves (110) and reflected seismic waves (114) may be detected by seismic receivers (120). On land a seismic receiver (120) may be a geophone (that records the velocity of ground motion) on an accelerometer (that records the acceleration of ground motion). In water, the seismic receiver may commonly be a hydrophone that records pressure disturbances within the water. Irrespective of its mechanical design or the quantity detected, seismic receivers (120) convert the detected seismic waves into electrical signals, that may subsequently be digitized and recorded by a seismic recorder (122) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receivers (120) may be positioned at a seismic receiver location that may be denoted (xᵣ, yᵣ) where x and y represent orthogonal axes on the surface of the earth (116) above the subterranean region of interest (102). Thus, the refracted seismic waves (110) and reflected seismic waves (114) generated by a single activation of the seismic source (106) may be represented as a three-dimensional “3D” volume of data with axes (xᵣ, yᵣ, t) where t indicates the recording time of the sample.

Typically, a seismic survey includes recordings of seismic waves generated by one or more seismic sources (106) positioned at a plurality of seismic source locations denoted (xₛ, yₛ). In some case, one seismic source (106) may be used to acquire the seismic survey, with the seismic source (106) being moved sequentially from one seismic source location to another. In other cases, a plurality of seismic sources (106) may be used each occupying and being activated (“fired”) sequential at a subset of the total number of seismic source locations used for the survey. Similarly, some or all of the seismic receivers (120) may be moved between firing of the seismic source (106). For example, seismic receivers (120) may be moved such that the seismic source (106) remains at the center of the area covered by the seismic receivers (120) even as the seismic source (106) is moved from one seismic source location to the next. Thus, a seismic dataset, the aggregate of all the seismic data acquired by the seismic survey, may be represented as a five-dimensional volume, with coordinate axes (xᵣ, yᵣ, yₛ, yₛ,t).

To determine earth structure, including the presence of hydrocarbons, the seismic data set may be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest to determine a drilling target. Critical steps in processing seismic data include a seismic migration. Seismic migration is a process by which seismic events are re-located in either space or time to their true subsurface positions.

Seismic noise may be any unwanted recorded energy that is present in a seismic data set. Seismic noise may be random or coherent and its removal, or “denoising,” is desirable in order to improve the accuracy and resolution of the seismic image. For example, seismic noise may include, without limitation, swell, wind, traffic, seismic interference, mud roll, ground roll, and multiples. A properly processed seismic data set may aid in decisions as to if and where to drill for hydrocarbons.

A typical seismic dataset may be 100 Terabytes to 1 Petabyte in size, corresponding to between 10 trillion (10¹³) and 100 trillion (10¹⁴) data samples. Clearly, processing such a large volume of data manually, without the aid of computer system configured to process seismic data, is completely unfeasible. Such a specially configured computer system may be termed a seismic processor, or seismic processing system. In addition to extensive arrays of tightly linked computer processing units (“CPUs”) a typical seismic processing system will include large arrays of graphical processing units (“GPUs”) to execute parallel processing, banks of high-speed tape or hard-drive readers to read the data from storage, high-speed tape or hard-drive writers to output final or intermediate results, and high-speed communication buses to connect these elements.

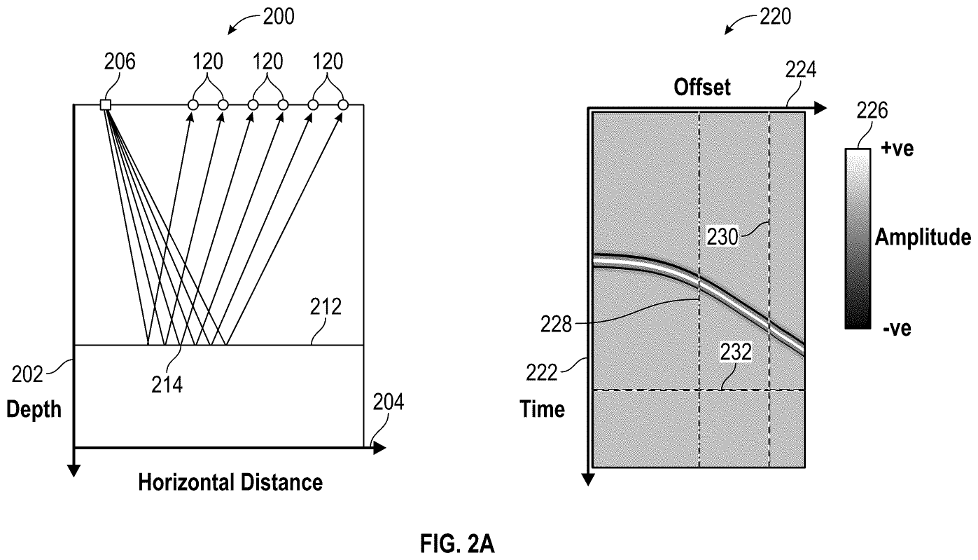

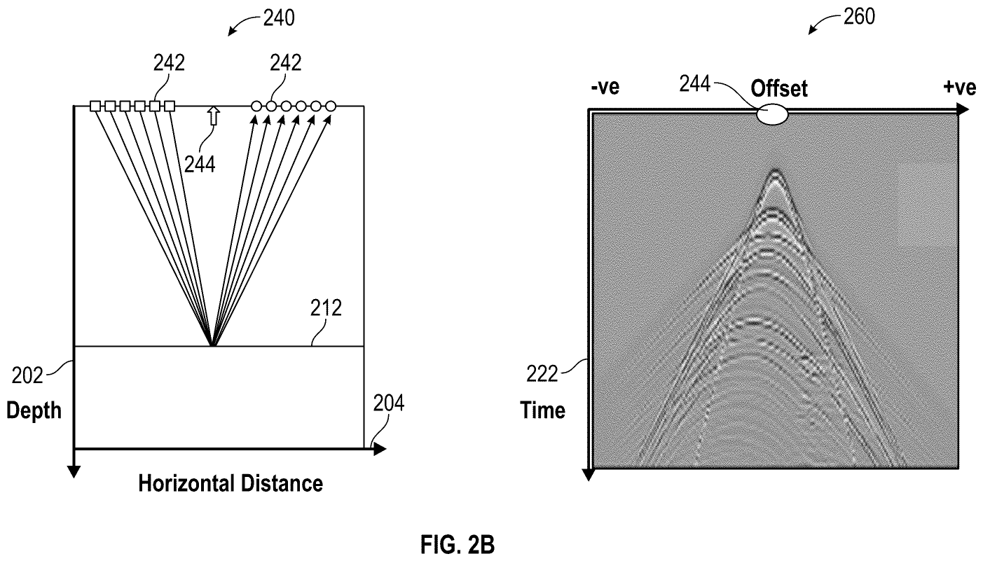

FIG. 2A depicts a two-dimensional transect through the five-dimensional volume, in accordance with one or more embodiments. Chart 200 depicts seismic ray paths, in depth, indicated by the vertical axis (202), and horizontal distance, indicated by the horizontal axis (204), taken by seismic waves. Seismic waves radiate from a source location (206), reflected from a seismic reflector (212) at a reflection point, such as reflection point (214), and are detected by a plurality of seismic receivers (120). Chart 220 depicts the data collected by the activation of the seismic source (106) at a single seismic source location (206). The vertical axis (222) of chart (220) indicates recoding time after the activation of the seismic source (106) and the horizontal axis (224) indicates the separation (“offset”) between the seismic source location (206) and each seismic location. A vertical transect (228) through chart (220) represents the recorded seismic disturbance (pressure, particle velocity, or acceleration) recorded by a single seismic receiver (120) as a function of recording time (222). The grayscale (226) depicts amplitude of the seismic disturbances with positive values shown as light colors and negative values shown as dark colors, or in some cases, vice versa.

Chart (220) depicts a type of space-time gather termed a “common shot-gather”, or simply “shot-gather”, so-called because the seismic data corresponding to a single source activation, or multiple activations of a seismic source at a single seismic source location (206) is gathered together in the display. Although seismic data are typically acquired one shot-gather at a time, it may not be convenient to process seismic data organized in this way and seismic data is frequently reorganized or “sorted” into other configurations. For example, data may be arranged and displayed as other types of space-time gathers, such as common receiver-gathers with each trace showing seismic waves emitted from different source locations but recorded at a common receiver location. Space-time gathers may be used to facilitate the inclusion or exclusion of data. For example, if it is determined that data at large offsets contain large amounts of noise, the traces with offsets larger than some cut-off value, such as cut-off value (230) may be set to zero (“muted”). Similarly, if late arriving signals are deemed undesirable for any reason, then data after a cut-off time, such as cut-off time (232) may be muted.

Both common shot-gathers and common receiver-gathers may have a different reflection point, such as reflection point (214) for each trace in the gather and hence each trace may not contain information about the same portion of the subsurface. Consequently, seismic data may often sorted or transformed into still other gathers to facilitate seismic processing. For example, seismic data are often transformed into a different type of space-time gather, such as a common-midpoint gather, for many seismic processing steps.

FIG. 2B shows a common-midpoint gather, in accordance with one or more embodiments. Chart (240) depicts a simplified geometry of a common-midpoint gather. A mid-point gather comprises a plurality of seismic source location and seismic receiver location pairs, such as pair (242), each pair sharing a common midpoint (244). In addition, chart (240) shows a ray path from each seismic source location to the corresponding receiver of the pair reflecting from a seismic reflector (212) at a depth indicated on the vertical axis (202). It is clear from chart (240) that the reflection points of each of the seismic source location seismic receiver pairs (242) coincide, or nearly coincide with one another and with the midpoint (244) and thus contain information about the same portion of the subsurface.

While chart (240) is a simplified example containing only a single reflector, in reality the subsurface consists of a plurality of reflectors at varying depth. An example of a common midpoint gather simulated for a multi-reflector portion of the subsurface is displayed in chart (260). The offset between seismic source location (206) and seismic receiver location (120) is displayed on the horizontal axis indicating positive and negative offsets on either side of a midpoint (244) on the horizontal axis (264) and recording time on the vertical axis (266).

### The Radon Transform and τ-p Domain

While common-shot gather (240) and common-midpoint gathers (260) are both types of space-time gather commonly used in seismic acquisition and processing, seismic data is also frequently transformed into other domains, such as the frequency-wavenumber domain, or the generalized Radon transform, to facilitate seismic processing. In particular, seismic data may be transformed using a Radon transform, into an intercept time (τ)-ray-parameter (p), or τ-p domain. The ray parameter, p, is defined as p=sin θ/v where θ is the angle between a seismic ray and the vertical and v is seismic propagation velocity.

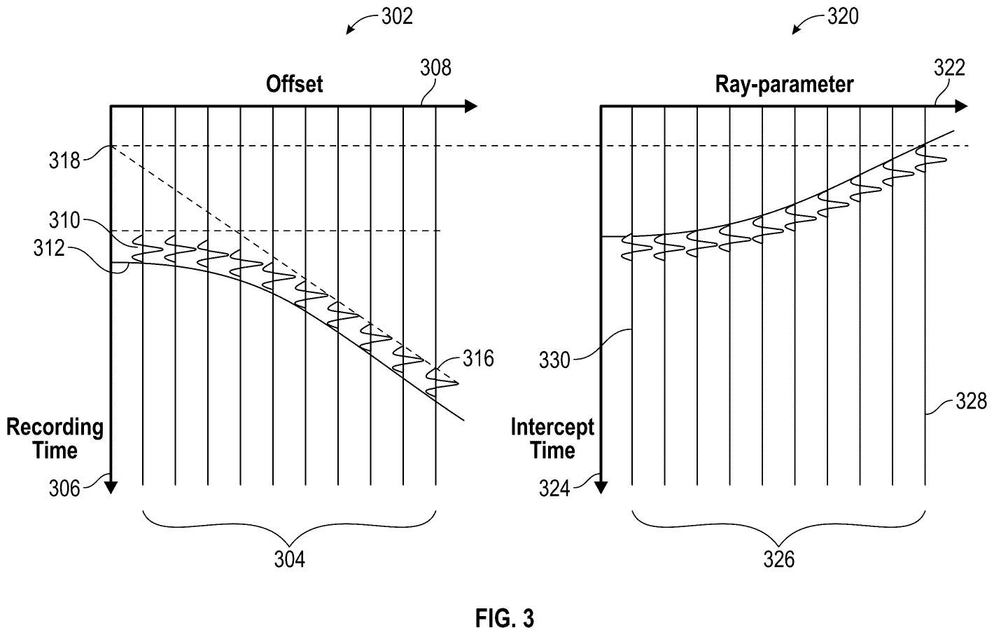

FIG. 3 illustrates a Radon transformation of a space-time gather (302) into a τ-p gather (320). The space-time gather (302), that may be a shot-gather (220) or a common midpoint gather (240), is made up of a plurality of traces (304) displayed against seismic source-seismic receiver offset, indicated on the horizontal axis (306), and against recording time, indicated on the vertical axis (308). In this pedagogic example each trace contains only a single detected seismic wave (310), although in real seismic data each trace will contain multiple detected seismic waves of varying amplitudes and recording times.

The detected seismic wave on each trace (304) in the space-time gather (302) is recorded at a recording tine that varies on the offset, or distance between the seismic source and seismic receiver. For example, in a simple homogeneous medium with a single horizontal seismic reflector, the recorded times of the plurality of traces may be described by a hyperbola (312). A Radon transform, [symbol] of a space-time gather, d(t,x), may be written as:

$$d ( τ , p ) = ℜ \{ d ( t , x ) \} = {\int }_{{x}_{min}}^{{x}_{max}} d ( τ + px , x ) dx . \qquad Equation ( 1 )$$

Graphically, Equation (1) is equivalent to integrating along a straight line, such as straight line (316) drawn from an intercept time (318) with a slope, p, across the space-time gather (302). The resulting τ-p gather (320) is made up from a plurality of traces (326) each corresponding to a value of ray-parameter, p, indicated on the horizontal axis (322) and a range of intercept times, indicated on the vertical axis (324). Note, that seismic signals with larger ray parameters, such as trace (328), typically occur with smaller intercept times than seismic signals with smaller ray parameters, such as trace (330). Physically, Equation (1) describes deconstructing the generally curved wavefronts arriving at a receiver array into a plurality of plane waves, i.e., wave with planar wavefronts.

As for space-time gathers, τ-p may be muted to remove components that are considered undesirable, or as required for subsequent processing steps. For example, the τ-p gather may be muted after an intercept time, such as intercept time (332). Such a mute may be termed a “late time mute” or more precisely a “late intercept time mute”. Alternatively, the τ-p may be muted before an intercept time, such as intercept time (334). Such a mute may be termed a “late intercept time mute”. Equally, traces within or outside a range of p values may be muted. For example, τ-p trace with a p value larger than a specified p value, such as p value (336) may be muted.

While, Equation (1) shows the Radon transform, also referred to as the forward Radon transform, the reverse transformation from the τ-p domain to the space-time domain may be performed using the inverse Radon transform, [symbol] ⁻¹. The inverse Radon transform may be written as:

$$d ( t , x ) = {ℜ}^{- 1} \{ d ( τ , p ) \} = \frac{1}{2 π} \frac{d}{dt} {H}_{t} {\int }_{{p}_{min}}^{{p}_{max}} d ( t + px , p ) dp \qquad Equation ( 2 )$$

where Hₜ is the Hilbert transform time operator. Just as the forward Radon transform transforms a space-time gather into to the intercept time-ray parameter gather, an inverse Radon transform transforms an intercept time-ray parameter gather into a space-time gather.

### Multiples

Typically, a seismic dataset must be processed to generate useful information, such as a seismic velocity model of the subterranean region of interest (102) or an image of seismic reflectors within the subterranean region of interest (102). Processing a seismic dataset comprises a sequence of steps designed, without limitation, to do one or more of the following: correct for near surface effects; attenuate noise; compensate for irregularities in the seismic survey geometry; calculate a seismic velocity model; image reflectors in the subsurface; or calculate a plurality of seismic attributes to characterize the subterranean region of interest (102). The processed seismic data may yield velocity models, images, and attributes that may aid in decisions governing when and where to drill for hydrocarbons.

In particular, processing a seismic dataset may include forming a seismic image of the structure of the subsurface region (102) using one or more of a group of processes called “seismic migration”. Seismic migration uses seismic velocity model to determine the location (124) at which reflected seismic waves (114) were generated from the radiated seismic waves (108). Many types of seismic migration method are available to practitioners of the art, each method having its unique combination of accuracy and computation cost characteristics. For example, seismic migration may include, without limitation, Kirchhoff time migration, Kirchhoff depth migration, Wave Equation migration, Reverse Time Migration, and Least-Squares Time Migration. Despite their differences, these and many other types of seismic migration share an important similarity, namely they assume that the seismic data to which they are applied consist of primary signals (or simply “primaries”). Primaries consist of seismic waves that travel as radiated seismic waves (108) from the seismic source (106), are reflected once at a seismic reflection point (124) then propagate as reflected seismic waves (114) to seismic receivers (120).

However, recorded seismic data typically include other propagation paths for seismic waves not included in this “single bounce” paradigm. In particular, seismic datasets typically include “multiples”; i.e., waves that have reflected upwards (the first “bounce”) from a first seismic reflector at a first depth, then reflected downwards (the second “bounce”) from a second seismic reflector at a second depth, shallower than the first depth, and reflected upwards to the surface (the third “bounce”) from a third seismic reflector at a third depth, deeper than the second depth. In some cases, the first and third seismic reflector may be the same reflector, but in many cases the first and second seismic reflectors will be distinct and lie at different depths. Seismic waves that have experienced three, or more, bounces of this nature are referred to as multiples.

Attempting to process seismic datasets containing primaries and multiples using seismic migration techniques that assume only primaries are present may lead to the imaging of false reflectors, the obscuring or blurring of real reflectors, loss of signal-to-noise ratio and other deleterious effects on the resulting seismic image.

Multiples may be divided into two types, “surface multiples” and “internal multiples”, depending on where the downward reflection occurs. For surface multiples the downward reflection (the second “bounce”) occurs at the surface of the earth (116). For internal multiples (sometimes called “interbed” multiples), the downward reflection occurs at a geological interface below the free surface. A person of ordinary skill in the art may use the terms internal multiple and interbed multiples synonymously and, although the term internal multiple is used herein, the scope of the invention should be interpreted to include both interbed multiples and internal multiples.

Surface multiples may be distinguished from primary reflections and partially or completely removed from seismic datasets more easily than are interbed multiples, at least in part, because they may be recorded by seismic receivers at the point at which the downward propagating reflection is generated, i.e., at the surface of the earth (116). In contrast, interbed multiples are typically not recorded at the point at which they are reflected downward, i.e., at seismic reflector below the surface of the earth.

### Marchenko Equation Demultiple

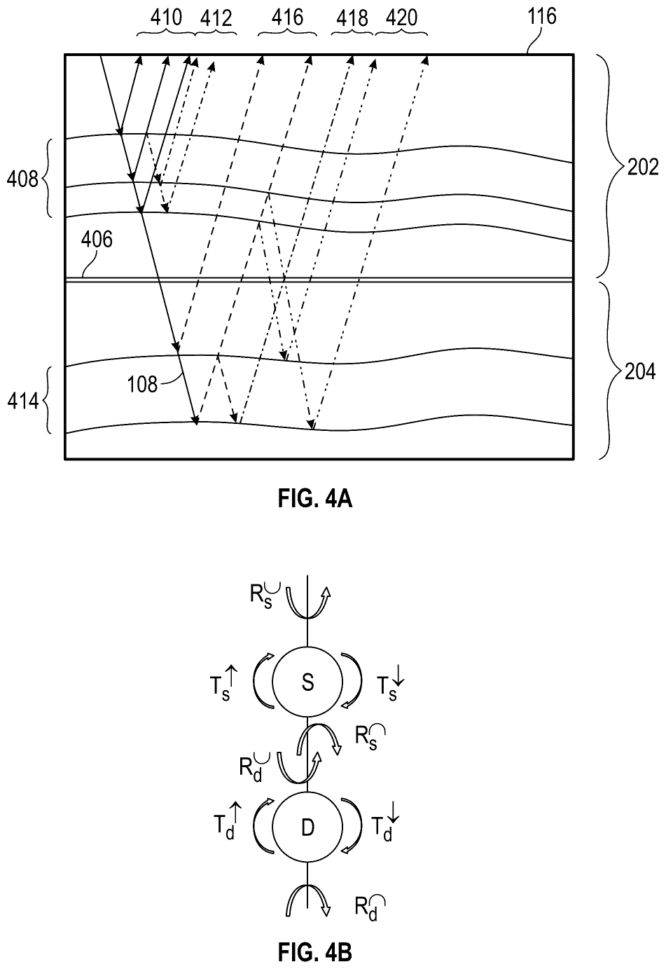

In accordance with one or more embodiments, internal multiples may be removed from a seismic dataset using a solution to the Marchenko equation. As shown in FIG. 4 this method may divide the subsurface into two portions: a shallow portion (402) and deeper portion (404) that may contain a target of interest to explorers for hydrocarbon. The method may express the complete seismic reflection response in terms of reflection and transmission responses of the two portions. The reflection response of the deeper portion (404) may then be extracted from the complete seismic reflection response.

FIG. 4A depicts a subterranean region divided into two portions, a shallower portion (402) and a deeper portion (404), by a dividing horizon (406). In practice, the dividing horizon may be selected to be a depth at, or slightly shallower than, a target of potential interest, such as a potential hydrocarbon reservoir. A radiated seismic wave (108) propagates first through the shallower portion (402) and then through the deeper portion (404). In passing through the shallower portion (402) the radiated seismic wave (108) may intersect shallow seismic reflectors (408) located within the shallower portion (402) and generate shallow primaries (410). In addition, the shallow primaries (410) may themselves be partially reflected by shallow seismic reflectors (408) before they reach the surface of the earth (116) and generate shallow internal multiples, such as shallow internal multiples (212). Similarly, in passing through the deeper portion (404) the radiated seismic wave (108) may intersect deeper seismic reflectors (414) located within the deeper portion (406) and generate deep primaries (416). In addition, the deep primaries (416) may themselves be partially reflected by deeper seismic reflectors (414) before they reach the surface of the earth (116) and generate deep internal multiples, such as deep internal multiples (418). However, in addition, deep primaries (416) may themselves be partially reflected by shallow seismic reflectors (408) before they reach the surface of the earth (116) and generate hybrid or “mixed” internal multiples, such as mixed internal multiples (420). Any internal multiple whose energy propagates across the dividing depth other than as the radiates seismic wave (108) may be categorized as a mixed internal multiple.

The propagation of seismic waves, including radiated seismic waves (108), primaries (410, 416) and multiples (412, 418, 420) may be simulated or modeled using an elastic wave equation or a simplification of the elastic wave equation, such as the acoustic wave equation. For example, using the detail-hiding notation of Berkhout, A. J., 1982: Seismic migration—Imaging of acoustic energy by wave field extrapolation, Elsevier ISBN: 9780444602008, the acoustic wave equation may be written as:

$$\partial X = A [ X ] \qquad Equation ( 3 )$$

where X may be a vector containing the acoustic pressure and vertical particle velocity. In accordance with one or more embodiments, the linear operator A is diagonalizable, with eigenstates U and D representing upward propagating and downward propagating seismic waves. In these circumstances the incident upward and downward propagating waves U and D and the scattered upward and downward propagating waves U′ and D′ may be related as:

$$( \begin{matrix}{U}^{′} \\ {D}^{′}\end{matrix} ) = ( \begin{matrix}{T}^{↑} & {R}^{⋃} \\ {R}^{⋂} & {T}^{↓}\end{matrix} ) ( \begin{matrix}U \\ D\end{matrix} ) such that ( \begin{matrix}{T}^{↑} & {R}^{⋃} \\ {R}^{⋂} & {T}^{↓}\end{matrix} ) ( \begin{matrix}{T}^{↓ *} & {R}^{⋂ *} \\ {R}^{⋃ *} & {T}^{↑ *}\end{matrix} ) = ( \begin{matrix}1 & 0 \\ 0 & 1\end{matrix} ) , \qquad Equation ( 4 )$$

where T^{↓} and T^{↑} are the transmission response of a portion of the subsurface to seismic waves from above and below, respectively; R^{∪} and R^{∩} are the reflection response of a portion of the subsurface to seismic waves from above and below, respectively. FIG. 4B illustrates the actions of these operators between and within the shallower portion (402) and the deeper portion (404).

The transmission responses (and their inverses) can be written as a sum of direct and multiply-scattered (“coda”) parts, e.g., T^{↓}=T_{dir}^{↑}+T_{coda}^{↓}. In simple, acoustic (single mode), dissipation-free cases, * denotes time reversed waves. In a more general setting however * may have a wider meaning and may also denote dissipative-effectual or pairs of non-reciprocal media reversal, or mode-reversal in multiple-mode supporting media.

Splitting the subsurface into two portions divided by the dividing depth (406) and denoting operators relating to the shallower portion (402) with the subscript “s”, e.g., Tₛ^{↓} and the deeper portion (404) with the subscript “d”, e.g., T_{d}^{↓}. the cumulative reflection response, R_{surf}, is measured above the shallow portion (202) may be expressed as:

$${R}_{surf} = {R}_{s}^{⋃} + {T}_{s}^{↑} {R}_{d}^{⋃} ( 1 + {R}_{s}^{⋂} {R}_{d}^{⋃} + {R}_{s}^{⋂} {R}_{d}^{⋃} {R}_{s}^{⋂} {R}_{d}^{⋃} + … ) {T}_{s}^{↓} . \qquad Equation ( 5 )$$

where, common to operator notation, the order of processes (trans-missions or reflections) should be read from right to left. Operator multiplication may be defined as follows:

$$[ AB ] ( {x}_{0}^{′} , {x}_{0} , ω ) = \int dyA ( {x}_{0}^{′} , y , ω ) B ( y , {x}_{0} , ω ) \qquad Equation ( 6 )$$

FIG. 4B summarizes the effect of each of the operators. From the perspective of the expression in Equation (5), there are three distinct wavefield (and multiples) contributions to R_{surf}. Using T^{↓}=T_{s,dir}^{↓}+T_{s,coda}^{↑} and T^{↑}=T_{s,dir}^{↑}+T_{s,coda}^{↑} Equation (2) may be rewritten as:

$${R}_{surf} = {R}_{s}^{⋃} + {\hat{ℛ}}_{d}^{⋃} + {ℳ}_{src} + {ℳ}_{rec} + {ℳ}_{dsd} + {ℳ}_{mix} , \qquad Equation ( 7 )$$

where

$${\hat{ℛ}}_{d}^{⋃} = {T}_{s , dir}^{↑} {R}_{d}^{⋃} {T}_{s , dir}^{↓} , \qquad Equation ( 8 )$$

$${ℳ}_{src} = {T}_{s , dir}^{↑} {R}_{d}^{⋃} {T}_{s , coda}^{↓} , \qquad Equation ( 9 )$$

$${ℳ}_{rec} = {T}_{s , coda}^{↑} {R}_{d}^{⋃} {T}_{s , dir}^{↓} , \qquad Equation ( 10 )$$

$${ℳ}_{dsd} = {T}_{s , dir}^{↑} {R}_{d}^{⋃} {R}_{s}^{⋂} {{R}_{d}^{⋃} ( 1 - {R}_{s}^{⋂} {R}_{d}^{⋃} )}^{- 1} {T}_{s , dir}^{↓} , \qquad Equation ( 11 )$$

and [symbol] ₘᵢₓ contains all the other cross-terms. From the point of view of the shallow reflectors (408) in the shallower portion (402) as a generator of internal multiples which are concurrent in time and interfering with the primary reflections (418) of the deeper portion (204) a few categories of multiples may be distinguished:
i. internal multiples generated by multiple scattering in the shallower portion (202) together with primaries from the shallow section,—Rₛ^{∪}
ii. internal multiples with multiple bounces prior to illuminating below the dividing depth (206), [symbol] _{src},
iii. internal multiples with multiple bounces after illuminating below the dividing depth (206), [symbol] _{rec},
iv. internal multiples resulting from reverberations between a shallow reflector (208) in the shallower portion (202) and a deeper reflector (214) in the deeper portion (204), and
v. internal multiples originating from combinations of types (2)-(4).

Further there are internal multiples generated in the deeper portion (404). These internal multiples are included in [symbol] _{d}^{∪} but these internal multiples will not be the focus of a Marchenko demultiple method focused on the elimination of internal multiples generated in the shallower portion (402).

The earliest recorded time of reflections, Tₛ^{↑}R_{d}^{∪}Tₛ^{↓}, from the deeper portion (404) may be given by a two-way transmission time t_{B}, and the separation into different categories of internal multiples naturally depends on the choice of the dividing depth (406) between the shallower portion (402) (“overburden”) and deeper portion (404) (“target”) or, equivalently, by the choice of t_{B}. However, the goal of one or more embodiments is the determination of, the reflection response of the deeper portion (404), [symbol] _{d}^{∪}, without any internal multiple reflections or scattering generated in the shallower portion (402) but with the shallower portion (402) transmission amplitude losses. Calculating [symbol] _{d}^{∪} may allow an immediate comparison with the full reflection response, R_{surf}, Cof the combined shallower portion (402) and deeper portion (404) as the phase and amplitude of the deep primaries remain unchanged.

To proceed and simplify the notation, Equation (5) may be rewritten in terms of the full target reflection response, [symbol] _{d}^{∪} measured at the surface:

$${\hat{R}}_{d}^{⋃} = {T}_{s}^{↑} {R}_{d}^{⋃} {T}_{s}^{↓} , \qquad Equation ( 12 )$$

and a modified shallower portion (402) reflection response, R_{d}^{∪}, also measured at the surface:

$${ℛ}_{s}^{⋃} = - {T}_{s}^{↑ - 1} {R}_{s}^{⋂} {T}_{s}^{↓ - 1} . \qquad Equation ( 13 )$$

As a result, Equation (5) may be rewritten as:

$${R}_{surf} = {R}_{s}^{⋃} + {{\hat{R}}_{d}^{⋃} ( 1 + {ℛ}_{s}^{⋃} {\hat{R}}_{d}^{⋃} )}^{- 1} , \qquad Equation ( 14 )$$

which may easily be inverted to obtain:

$${\hat{R}}_{d}^{⋃} = ( {R}_{surf} - {R}_{s}^{⋃} ) {( 1 - {ℛ}_{s}^{⋃} ( {R}_{surf} - {R}_{s}^{⋃} ) )}^{- 1} . \qquad Equation ( 15 )$$

In accordance with one or more embodiments, to determine [symbol] _{d}^{∪} from Equation (15) it is convenient to introduce two so-called “dereverberation operators”, \tilde{v}⁺, and v⁺. The first dereverberation operator may be written as:

$${\tilde{v}}^{+} ( {x}_{0}^{′} , {x}_{0} , ω ) = \int {dx}_{i} {T}_{dir}^{↑} ( {x}_{0}^{′} , {x}_{i} , ω ) {T}^{↑ - 1} ( {x}_{i} , {x}_{0} , ω ) = 1 + {T}_{dir}^{↑} {{T}^{⌣}}_{coda}^{↑} , \qquad Equation ( 16 )$$

and the second dereverberation operator may be written as:

$${v}^{+} ( {x}_{0}^{′} , {x}_{0} , ω ) = \int {dx}_{i} {T}^{↓ - 1} ( {x}_{0}^{′} , {x}_{i} , ω ) {T}_{dir}^{↓ - 1} ( {x}_{i} , {x}_{0} , ω ) = 1 + {{T}^{⌣}}_{coda}^{↓} {T}_{dir}^{↓} , \qquad Equation ( 17 )$$

where T^{↑-1} and T^{↓-1} are the left and right inverse of T^{↑} and T^{↓}, respectively. In addition, x₀ and x′₀ denote source and receiver locations on the surface of the earth (106) and xᵢ denotes a position vector on a subsurface datum, such as the dividing depth (406). In the event that inverse transmissions do not exist mathematically, Moore-Penrose pseudoinverses may be used for T^{↑-1} and T^{↓-1}.

From the definitions in Equation 16, we can see that both dereverberation operators are evaluated at the surface of the earth (106), i.e., have their source and receiver at the acquisition plane and, unlike transmissions, they are independent of up-down decomposition normalization choice. Using Equations (14), (15) and (16) [symbol] _{d}^{∪} may be defined as:

$${\hat{ℛ}}_{d}^{⋃} = {\tilde{v}}_{s}^{+} {\hat{R}}_{d}^{⋃} {v}_{s}^{+} = {\tilde{v}}_{s}^{+} ( {R}_{surf} - {R}_{s}^{⋃} ) ( 1 - {{ℛ}_{s}^{⋃} ( {R}_{surf} - {R}_{s}^{⋃} )}^{- 1} ) {v}_{s}^{+} , \qquad Equation ( 18 )$$

where the subscript s indicates that only transmission and reflections from the shallow portion (402) are considered. Equations (18) features \tilde{v}s⁺, vₛ⁺Rₛ^{∪}, and [symbol] ₛ^{∪} which are not directly measurable, and as a result Equation (18) cannot be immediately applied.

To address this challenge, conventional Marchenko approaches applied mutes to the wavefields in the space time domain. For example, the bounding time, t₀, may be specified in the space-time domain as a constant bounding time, i.e., t₀=const. In other case, an offset-variable bounding time may be used however, establishing the correct offset-dependence is frequently problematic. Furthermore, this conventional approach may make separating the multiple-suppressing events generated inside high velocity layers from event auto-correlations challenging, particularly at mid and far offsets. Finally, space-time gathers are ill-suited to handling reflections at or near the critical point (the angle at which no energy is transmitted through a layer boundary and all the energy is reflected) that commonly occur at far-offsets. These mutes work well only where there is no seismic velocity contrast between subsurface layers and then they are applied. However, in reality, velocity contrasts are always present, they are the main source of multiple reflections in practice, and application of mutes in the space-time domain may produce errors and artifacts.

However, in accordance with one or more embodiments, each of the challenges faced by conventional methods may be solved or mitigated by applying a mute in the τ-p domain using a bounding intercept time dependent on the ray parameter, τ_{B}(p). Specifically, [symbol] _{d}^{∪} may be written as:

$${\hat{ℛ}}_{d}^{⋃} = {\tilde{v}}_{s}^{+} {Θ}_{d} [ {R}^{⋃} {v}_{s}^{+} ] {( 1 - χ )}^{- 1} where χ = {\sum }_{s}^{- 1} {{\overline{Θ}}_{s}^{-} [ {\tilde{v}}_{s}^{+} {R}^{⋃} ]}^{*} {Θ}_{d} [ {R}^{⋃} {v}_{s}^{+} ] \qquad Equation ( 19 )$$

and where Σₛ=T_{s,dir}^{↑*}T_{s,dir}^{↓} is the is the two-way transmission correction. The operators Θ̅_{d}[U]=U−Θ̅⁻_{S}[U] and Θ̅⁻_{S}[U] mute the wavefield U in the τ-p domain before and after a ray parameter dependent intercept time, τ_{B}(p), respectively. Specifically, the operators convert a space-time gather into the τ-p gather, mute the traces in the τ-p gather using the ray parameter dependent intercept time, τ_{B} (p), and return the τ-p gather into the space-time domain as a space-time gather using an inverse Radon transform. The mutes Θ̅⁻_{S} and Θ_{d} may be found by reversing the source and receiver locations of the mutes Θ̅⁻_{S} and Θ̅⁻_{d}[U] respectively. This application of the Marchenko algorithm in the τ-p is thus an improvement on the conventional approach of applying the Marchenko algorithm in the t-x domain.

The deverberation operator, vₛ⁺, may be determined iteratively, or recursively, as:

$${v}_{s}^{+} = {\sum }_{j = 0}^{∞} {Ω}_{j} [ {v}_{s , e}^{+} ] \qquad Equation ( 20 )$$

where Ωⱼ[x]=Θₛ⁺[R^{∪*}Θ_{S}⁻[R^{∪}Ωⱼ₋₁[x]]], with Ω₀[x]=x, and v_{s,e}⁺, =vₛ⁺−Θ_{S}⁺[v_{S}⁺]. Here Θ_{S}⁺[x] mutes before the ray parameter dependent intercept time, τ₀ (p).

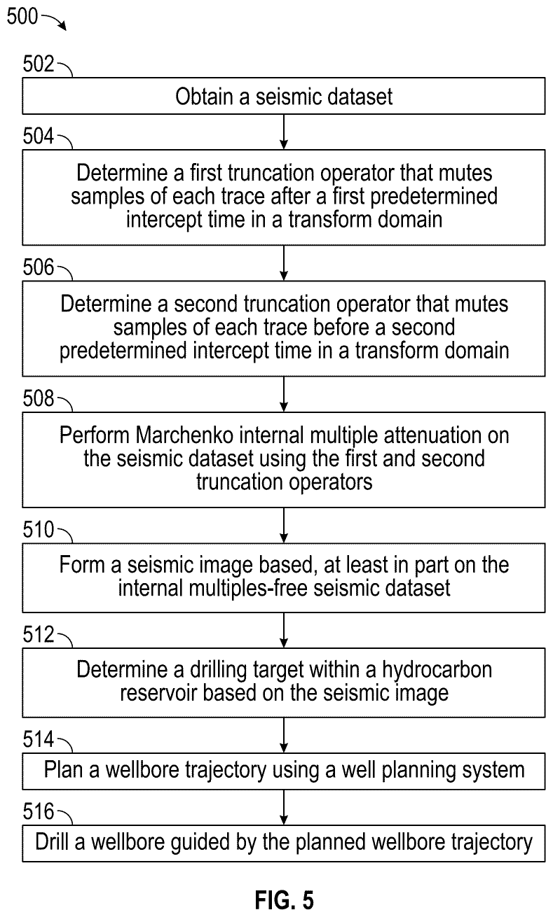

FIG. 5 shows a flowchart in accordance with one or more embodiments. In Step 502 a seismic dataset may be obtained. The seismic dataset may be a calibrated seismic dataset, that is the acquisition and processing of the seismic dataset prior to the commencement of the workflow described in the flowchart have been performed in such a manner as to determine the absolute amplitudes of the samples of seismic dataset.

In Step 504, a first truncation operator that mutes samples of each trace after a first predetermined intercept time in a transform domain may be determined. The first predetermined intercept time may be determined based upon the estimated depth of a target layer of interest in the subsurface of the earth. The first truncation operator may include determining a transformed gather composed of a seismic trace for each of a plurality of ray-parameters, by transforming the space-time gather from a space-time domain to an intercept-time-ray-parameter (“τ-p”) domain using a τ-p transform. The first truncation operator may further include determining a muted gather by muting each trace of the transformed gather based on a first predetermined intercept time. In some embodiments, the first predetermined intercept time may be a ray-parameter dependent intercept time. Note, that an accurate seismic propagation velocity model is not required to determine a predetermined intercept time. Further the first truncation operator may include inverting the muted gather using an inverse τ-p transform to produce a first muted space-time gather.

In Step 506, a second truncation operator that mutes samples of each trace before a first predetermined intercept time in a transform domain may be determined. The second truncation operator may include determining a transformed gather, composed of a seismic trace for each of a plurality of ray-parameters, by transforming the space-time gather from a space-time domain to an intercept-time-ray-parameter (“τ-p”) domain using a τ-p transform and muting the transformed gather based on a second predetermined intercept time. In some embodiments, the predetermined intercept time may be determined based upon the duration, or the bandwidth, of a seismic wavelet emitted by the seismic source before or after wavelet correlation and/or deconvolution. The second truncation operator may further include inverting the muted gather using an inverse τ-p transform to obtain a second muted space-time gather.

Either the first or second truncation operators, in Steps 504 or 506, may further include muting one or more traces in the (“τ-p”) domain. For example, traces corresponding to large ray-parameters may be muted (set to zero amplitude) to exclude ray-parameter producing total internal reflections. In contrast to the muting performed by the muting operators this muting entails setting the entire trace to zero for each of the selected ray-parameters.

In Step 508 a Marchenko internal multiple attenuation may be performed on the seismic dataset using the first and second truncation operators. Steps 504, 506, and 508 may be performed by a seismic processing system. A seismic processing system may be composed of one or more computer systems including associated input devices, such as tape drives; computer memory; output devices, such as hard drives; and connecting networks and buses. Further, a seismic processing system may include appropriate software configured to execute each of the steps in a seismic processing chain or workflow.

In Step 510 a seismic image may be formed based, at least in part on the internal multiples-free seismic dataset. In one or more embodiments, the forming of a seismic image may include the determination of a seismic velocity model using the internal multiples-free seismic dataset, and the migration of the internal multiples-free seismic dataset using the seismic velocity model to determine the seismic image.

In Step 512, a drilling target within a hydrocarbon reservoir may be determined based, at least in part, on the seismic image. The determination may include interpretating the seismic image, for example using a seismic interpretation workstation, to identify geological formations, such as high porosity rocks formed into anticlines, that may be favorable to the trapping of hydrocarbons. Further, the determination of a drilling target may take account of the location and trajectory of preexisting wellbores and their historical hydrocarbon production data, such as their fluid production rates and the relative proportions of water and hydrocarbon in the produced fluids.

In Step 514, a planned wellbore trajectory may be determined to intersect the drilling target. In addition, to the depth and geographic location of the drilling target, the planned wellbore trajectory may be influenced by suitable locations for the surface position of the wellhead. For example, for offshore drilling targets it may be advantageous to drill the wellbore from a preexisting drilling or production rig, or from a natural or man-made island. Alternatively, when the drilling target is located beneath an area of dry land it may be advantageous to drill the wellbore from a preprepared drilling location already provided with access roads, power supplies, drilling mud pits or tanks and temporary crew accommodations. In addition, to the wellhead and drilling target locations a wellbore trajectory may be influenced by shallow drilling hazards, such as gas pockets, or subterranean water flows, or unstable or metastable fault zones. Further the wellbore trajectory may be limited by the maximum curvature (“dog-leg”) that the drillstring may tolerate, and the maximum torque and drag that the available drilling system may overcome. A wellbore planning system, composed of one or more computer systems and appropriate wellbore planning software may be used to plan the wellbore trajectory. The wellbore planning system may further determined planned wellbore caliper changes as a function of depth and the associated placement of casing (“casing points”) to provide mechanical support for the wellbore during and after drilling and the protection of the wellbore from the undesired influx of formation fluids into the wellbore.

In Step 516 a wellbore guided by the planned wellbore trajectory may be drilled using a drilling system depicted in FIG. 15.

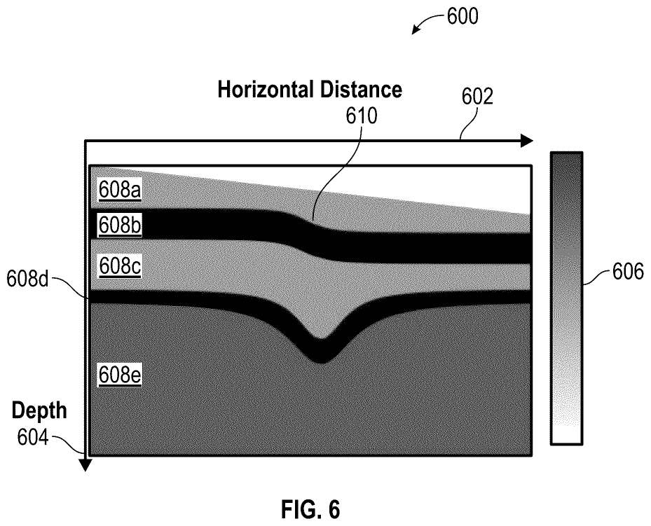

The workflow depicted in flowchart (500) may be illustrated in FIGS. 6-13, including an illustration of the improvement of the one or more embodiments described by flowchart (500) over preexisting methods known to a person of ordinary skill in the art.

FIG. 6 depicts an earth model (600) displayed as a function of horizontal position, indicated by the horizontal axis (602), and of depth, indicated on the vertical axis (604). The velocity of seismic wave propagation within the earth model (600) is displayed using the grayscale (606) with dark colors indicating large velocities and the light colors indicating low velocities. The earth model (600) displays several layers (608a-e) representing different geological formations, rock types, or facies, and may be regarded as a simplified representation of the earth that nevertheless presents may common geological features, such as dipping interfaces (610), and varying layer thicknesses.

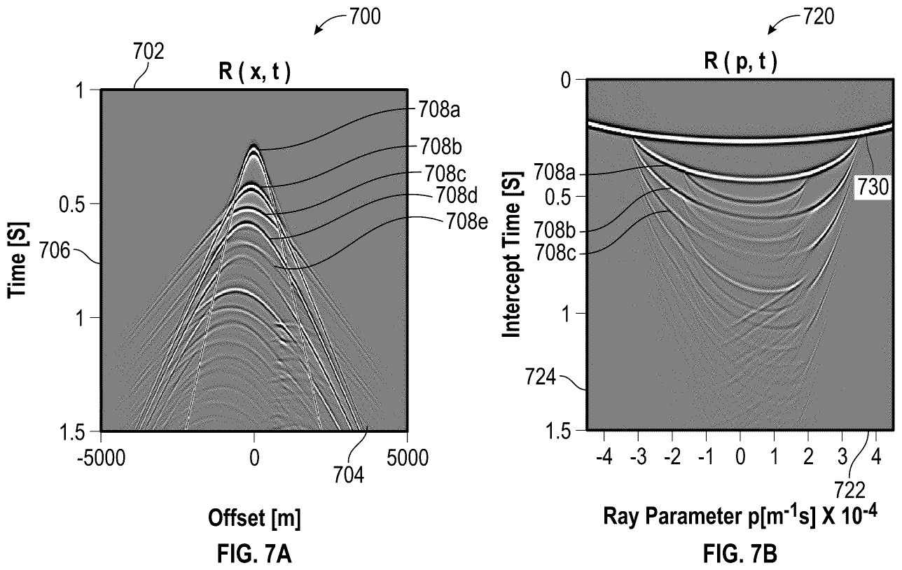

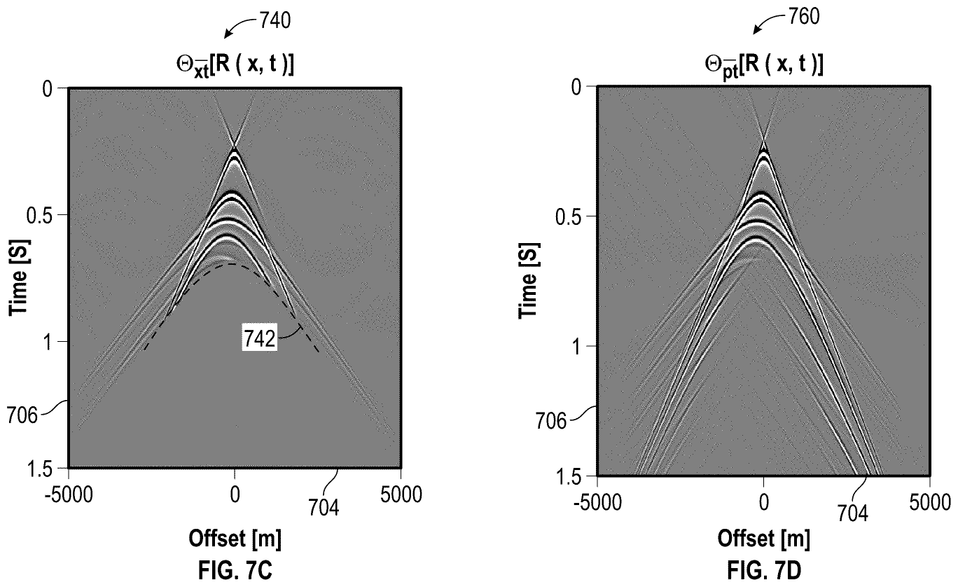

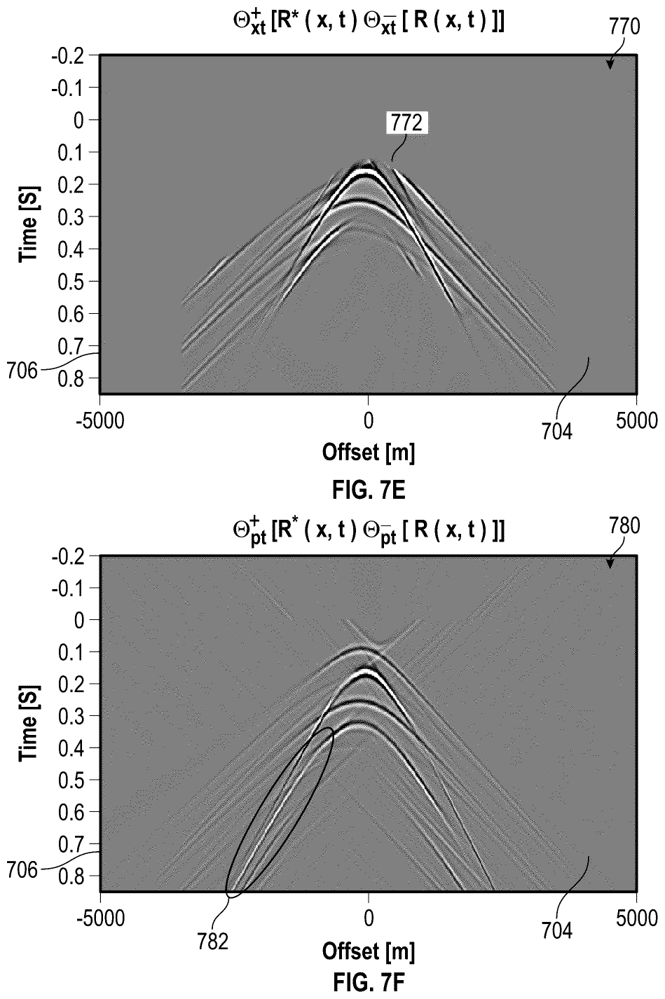

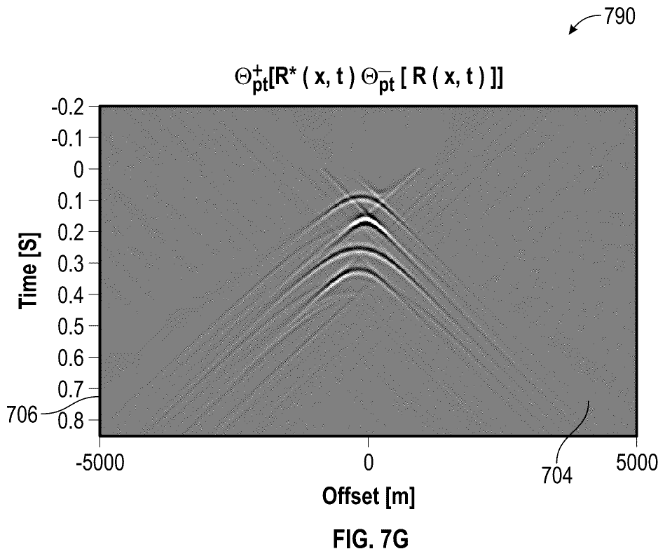

FIGS. 7A-7G shows the results of applying a conventional Marchenko method solely in the space-time domain and is presented here to illustrate the short-comings of conventional approaches. FIG. 7A shows a shot-gather (700), i.e., a single source location (702) and a plurality of receiver locations, indicated on the horizontal axis (704), displayed as a function of recording time, indicated on the vertical axis (706). The direct waves from the source to the receiver has been removed from display leaving only the reflection, such as reflections (708a-e), from the plurality of reflectors lying beneath the seismic source and seismic receiver array.

FIG. 7B displays the reflection response (720) in the intercept time-ray parameter (τ-p) domain, in accordance with one or more embodiments. Reflection response is displayed as a function of ray parameter displayed on the horizontal axis (722) and the intercept time displayed on the vertical axis (724). At small positive and negative values of the ray parameter each individual reflection, e.g., (708a-c), in the space-time domain correspond to a reflection, such as reflections (722a-c) in the τ-p domain. However, at larger or farther offsets that may be beyond the critical angle of reflection for one or more reflector, fewer reflections, such as reflection (730) are manifested.

FIG. 7C illustrates the effect of a truncation operator applied to the space-time gather (700) in the space-time domain in accordance with the conventional Marchenko equation demultiplex conventional approach. The offset-dependent space-time mute (742) marks the recording time after which reflections amplitudes are set to zero. In contrast FIG. 7D shows the effect of a first truncation operator, θ⁻, applied in the τ-p domain. FIG. 7D is the result of a three-step process: first transforming the space-time gather (700) into the τ-p domain using a Radon (or equivalently a forward Radon) transform; then muting the τ-p gather (720) using a mute intercept-time that may be ray-parameter dependent; and finally transforming the muted τ-p gather back into the space-time domain using an inverse Radon transform to obtained a τ-p domain muted space-time gather (760).

Further, FIG. 7E shows the result (770) of applying a first truncation operator in the space-time domain followed by a second truncation operator in the space-time domain as in the conventional Marchenko equation demultiplex approach. A person of ordinary skill in the art will readily recognize the short-comings of this result, for example the presence of discontinuous events, such as event (772). In contrast, FIG. 7F shows the result (780) of applying a first truncation operator in the τ-p domain followed (after a convolution by the time reversed space-time gather) by a second truncation operator in the τ-p domain. The resulting space-time (780) does not exhibit the abrupt discontinuities seen in (780) but still exhibits noise artifacts such as (782). FIG. 7G shows the results (790) of applying a first truncation operator in the τ-p domain followed (after a convolution by the time reversed space-time gather) by a second truncation operator in the τ-p domain and a further mute removing the contributions from large ray-parameters. The resulting space-time gather (790) exhibits neither the erroneously terminated events (772) not the noise artifacts (782).

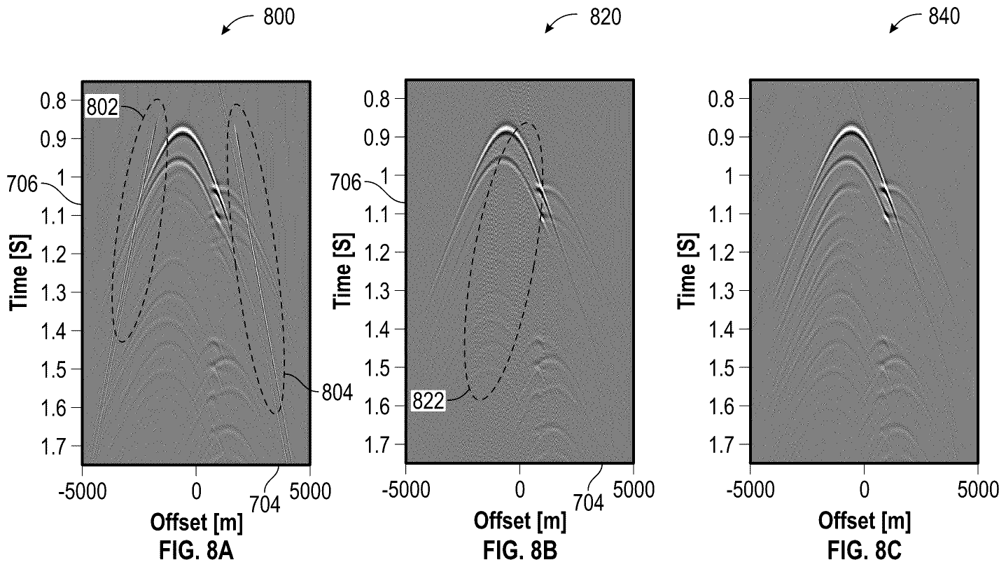

FIGS. 8A-8C compare the seismic data estimated after the removal of the internal multiples obtained using space-time domain truncation operators (800), τ-p domain truncation operators (820), and τ-p domain truncation operators with additional muting of large magnitude ray parameters (840).

FIG. 8A shows seismic data after the removal of the predicted internal multiples (800) obtained using the conventional space-time truncated Marchenko equation demultiple method. Although the results are relatively noise free at small offsets, noise artifacts (802) and (804) are clearly visible at intermediate and large offsets. In contrast, noise artifacts (802) and (804) are largely absent at intermediate and large offsets in the seismic data after the removal of the predicted internal multiples obtained using the τ-p domain truncation operators (820). However, result (820) does illustrate low frequency noise (822). Finally, space-time gather (840) illustrates the seismic data after the removal of the predicted internal multiples obtained using the τ-p domain truncation operators and additional large ray-parameter trace muting. Space-time gather (840) exhibits neither noise artifacts (802) and (804) at intermediate and large offsets, nor low frequency noise (822), and is a clear improvement over the conventional result (800).

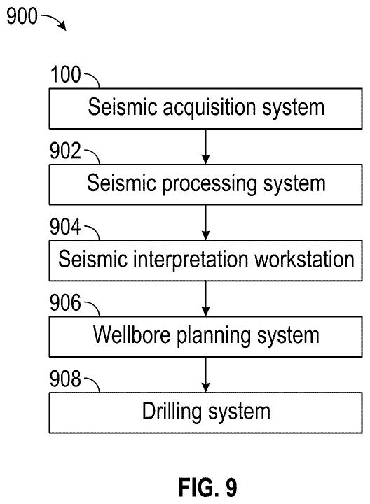

FIG. 9 shows a block diagram of systems (900) in accordance with one or more embodiments. Each system may be coupled to one or more other systems within the series of systems (900). The seismic acquisition system (100) may be configured to record a seismic dataset generated during a seismic survey of a subterranean region (102), as previously described in FIG. 1. The seismic dataset may be physically transferred to the seismic processing system (902) in the form of tape readers or high-capacity hard drives.

The seismic processing system (902) may receive the seismic dataset and may be used to process the seismic dataset. This may include processing steps such as pre-processing, noise attenuation (e.g., multiple attenuation), near-surface corrections, velocity analysis, migration (i.e., imaging), or attribute generation. In some embodiments, the seismic processing system (902) may be used to estimate, attenuate, or remove internal multiple reflections. Further, the seismic processing system (902) may be used to form a seismic image based on the multiple-attenuated seismic dataset. The seismic image may be transferred to a seismic interpretation workstation (904).

The seismic interpretation workstation (904) may be used to identify and label subsurface structures, such as geological layers, geological layer boundaries, faults and fractures, and boundaries between different types of pore fluids. In particular, a seismic interpretation workstation may be used to determine a location of a hydrocarbon reservoir (104) (or other subterranean features), based on the seismic image. Typically, a seismic interpretation workstation may be configured to facilitate interaction between the seismic interpretation workstation (904), the seismic data and images stored within the seismic interpretation workstation (904) and a human user. To achieve this the seismic interpretation workstation (904) may be equipped with two-dimensional (monitors) or three-dimensional (immersive or virtual reality) display capabilities and one or more mouse, wand, or equivalent devices designed to enable the identification, isolation, and labelling of subterranean features.

Knowledge of the existence and location of the hydrocarbon reservoir (104) and other subterranean features may be transferred to a wellbore planning system (906). The wellbore planning system (906) may use information regarding the hydrocarbon reservoir (104) location to plan a well, including a wellbore trajectory from the surface (116) of the earth to penetrate the hydrocarbon reservoir (104). In addition, to the depth and geographic location of the hydrocarbon reservoir (104), the planned wellbore trajectory may be constrained by surface limitations, such as suitable locations for the surface position of the wellhead, i.e., the location of potential or preexisting drilling rig, drilling ships or from a natural or man-made island. In addition, to the wellhead and drilling target locations a wellbore trajectory may be influenced by shallow drilling hazards, such as gas pockets, or subterranean water flows, or unstable or metastable fault zones. Further the wellbore trajectory may be constrained by limitations of the available drilling systems, e.g., by the maximum curvature (“dog-leg”) that the drillstring may tolerate, and the maximum torque and drag that the available drilling system may overcome. A wellbore planning system, composed of one or more computer systems and appropriate wellbore planning software may be used to plan the wellbore trajectory. The wellbore planning system may further determined planned wellbore caliper changes as a function of depth and the associated placement of casing (“casing points”) to provide mechanical support for the wellbore during and after drilling and the protection of the wellbore from the undesired influx of formation fluids into the wellbore.

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. The wellbore plan may be updated during the drilling of the wellbore. For example, the wellbore plan may be updated based upon new data about the condition of the drilling equipment, and about the subterranean region (102) through which the wellbore is drilled.

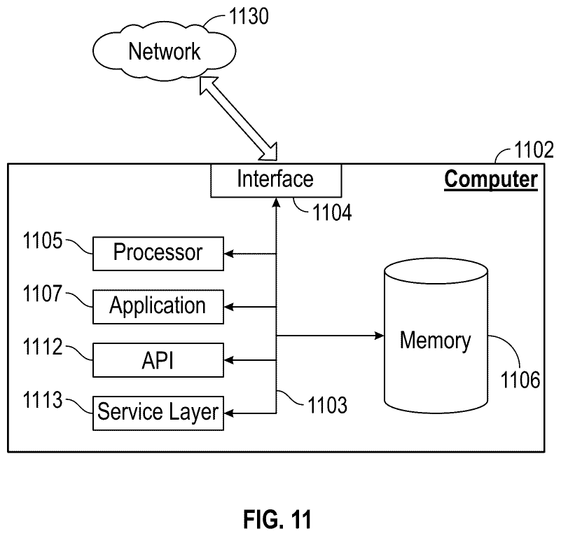

The wellbore planning system may include computer systems, such as the computer system described in FIG. 11, and may further include dedicated software to determine the planned wellbore path and associated drilling parameters, such as the planned wellbore diameter, the location of planned changes of the wellbore diameter, the planned depths at which casing will be inserted to support the wellbore and to prevent formation fluids entering the wellbore, and the drilling mud weights (densities) and types that may be used during drilling the wellbore.

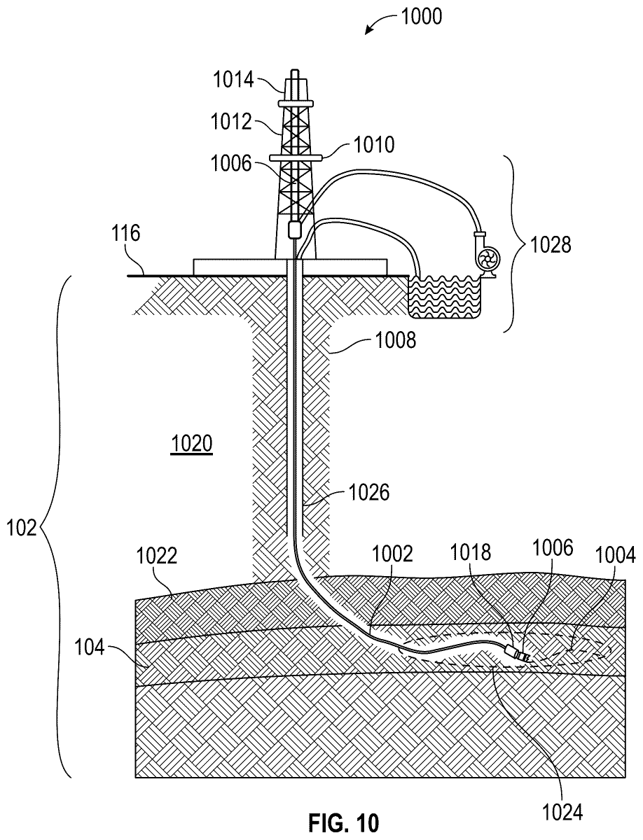

Information regarding the planned wellbore and wellbore trajectory may be transferred to the drilling system (1000) described in FIG. 10. The drilling system (1000) may drill the wellbore along the planned wellbore path to access and produce the hydrocarbon reservoir (104).

Systems such as the seismic acquisition system (100), the seismic processing system (902), the seismic interpretation workstation (904), and the wellbore planning system (906) may all include or be implemented on one or more computer systems such as the one shown in FIG. 9.

FIG. 10 shows a drilling system (1000) in accordance with one or more embodiments. As shown in FIG. 10, a wellbore (1102) following a wellbore trajectory (1004) may be drilled by a drill bit (1006) attached by a drillstring (1008) to a drill rig (1010) located on the surface (116) of the earth. The drill rig (1010) may include framework, such as a derrick (1012) to hold drilling machinery. A top drive (1014) sits at the top of the derrick (1012) and provides clockwise torque via the drive shaft (1016) to the drillstring (1008) in order to drill the wellbore (1002). The drillstring (1008) may comprise a plurality of sections of drillpipe attached at the uphole end to the drive shaft (1016) and downhole to a bottomhole assembly (“BHA”) (1018). The BHA may be composed of a plurality of sections of heavier drillpipe and one or more measurement-while-drilling (“MWD”) tools configured to measure drilling parameters, such as torque, weight-on-bit, drilling direction, temperature, etc., and one or more logging-while-drilling (“LWD”) tools configured to measure parameters of the rock surrounding the wellbore (1002), such as electrical resistivity, density, sonic propagation velocities, gamma-ray emission, etc.

The wellbore (1002) may traverse a plurality of overburden (1020) layers and one or more cap-rock (1022) layers to a hydrocarbon reservoir (104) within the subterranean region (102), and specifically to a drilling target (1024) within the hydrocarbon reservoir (104). The wellbore trajectory (1004) may be a curved or a straight trajectory. All or part of the wellbore trajectory (1004) may be vertical, and some wellbore trajectory (1004) may be deviated or have horizontal sections. One or more portions of the wellbore (1002) may be cased with casing (1026) in accordance with the wellbore plan.

To start drilling, or “spudding in” the well, the hoisting system lowers the drillstring (1008) suspended from the derrick (1012) towards the planned surface location of the wellbore. An engine, such as a diesel engine, may be used to supply power to the top drive (1014) to rotate the drillstring (1008). The weight of the drillstring (1008) combined with the rotational motion enables the drill bit (1006) to bore the wellbore.

The near-surface is typically made up of loose or soft sediment or rock, so large diameter casing (1026), e.g., “base pipe” or “conductor casing,” is often put in place while drilling to stabilize and isolate the wellbore. At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface (116) of the earth.

Drilling may continue without any casing (1026) once deeper, or more compact rock is reached. While drilling, a drilling mud system (1028) may pump drilling mud from a mud tank on the surface (116) through the drill pipe. Drilling mud serves various purposes, including pressure equalization, removal of rock cuttings, and drill bit cooling and lubrication.

At planned depth intervals, drilling may be paused and the drillstring (1008) withdrawn from the wellbore. Sections of casing (1026) may be connected and inserted and cemented into the wellbore. Casing string may be cemented in place by pumping cement and mud, separated by a “cementing plug,” from the surface (116) through the drill pipe. The cementing plug and drilling mud force the cement through the drill pipe and into the annular space between the casing and the wellbore wall. Once the cement cures, drilling may recommence. The drilling process is often performed in several stages. Therefore, the drilling and casing cycle may be repeated more than once, depending on the depth of the wellbore and the pressure on the wellbore walls from surrounding rock.

Due to the high pressures experienced by deep wellbores, a blowout preventer (BOP) may be installed at the wellhead to protect the rig and environment from unplanned oil or gas releases. As the wellbore becomes deeper, both successively smaller drill bits and casing string may be used. Drilling deviated or horizontal wellbores may require specialized drill bits or drill assemblies.

A drilling system (1000) may be disposed at and communicate with other systems in the well environment. The drilling system (1000) may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a target zone (1024) is reached, or the presence of hydrocarbons is established.

FIG. 11 shows a computer system in accordance with one or more embodiments. The computer system is used to provide computational functionalities associated with described algorithms, methods, functions, processes, flows, and procedures as described in the present disclosure, according to one or more embodiments. The illustrated computer (1102) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1102) may include a computer that includes an input device, such as a keypad, keyboard, touch screen, or other device that can accept user information, and an output device that conveys information associated with the operation of the computer (1102), including digital data, visual, or audio information (or a combination of information), or a graphical user interface (GUI).

The computer (1102) can serve in a role as a client, network component, a server, a database or other persistency, or any other component (or a combination of roles) of a computer system for performing the subject matter described in the instant disclosure. The illustrated computer (1102) is communicably coupled with a network (1130). For example, a generic computer (1102), seismic processing system (806), and seismic interpretation workstation (808) may be communicably coupled using a network (1130). In some implementations, one or more components of the computer (1102) may be configured to operate within environments, including cloud-computing-based, local, global, or other environment (or a combination of environments).

At a high level, the computer (1102) is an electronic computing device operable to receive, transmit, process, store, or manage data and information associated with the described subject matter. According to some implementations, the computer (1102) may also include or be communicably coupled with an application server, e-mail server, web server, caching server, streaming data server, business intelligence (BI) server, or other server (or a combination of servers).

The computer (1102) can receive requests over network (1130) from a client application, for example, executing on another computer (1102) and responding to the received requests by processing the said requests in an appropriate software application. For example, since seismic processing and seismic interpretation may be not be sequential, each computer (1102) system may receive requests over a network (1130) from any other computer (1102) and respond to the received requests appropriately. In addition, requests may also be sent to the computer (1102) from internal users (for example, from a command console or by other appropriate access method), external or third-parties, other automated applications, as well as any other appropriate entities, individuals, systems, or computers.

The computer (1102) includes an interface (1104). Although illustrated as a single interface (1104) in FIG. 11, two or more interfaces (1104) may be used according to particular needs, desires, or particular implementations of the computer (1102). The interface (1104) is used by the computer (1102) for communicating with other systems in a distributed environment that are connected to the network (1130). Generally, the interface (1104) includes logic encoded in software or hardware (or a combination of software and hardware) and operable to communicate with the network (1130). More specifically, the interface (1104) may include software supporting one or more communication protocols associated with communications such that the network (1130) or interface's hardware is operable to communicate physical signals within and outside of the illustrated computer (1102).

The computer (1102) also includes at least one computer processor (1105). Although illustrated as a single computer processor (1105) in FIG. 11, two or more processors may be used according to particular needs, desires, or particular implementations of the computer (1102). Generally, the computer processor (1105) executes instructions and manipulates data to perform the operations of the computer (1102) and any algorithms, methods, functions, processes, flows, and procedures as described in the instant disclosure.

The computer (1102) further includes a memory (1106) that holds data for the computer (1102) or other components (or a combination of both) that can be connected to the network (1130). For example, memory (1106) can be a database storing data consistent with this disclosure. Although illustrated as a single memory (1106) in FIG. 11, two or more memories may be used according to particular needs, desires, or particular implementations of the computer (1102) and the described functionality. While memory (1106) is illustrated as an integral component of the computer (1102), in alternative implementations, memory (1106) can be external to the computer (1102).

The application (1107) is an algorithmic software engine providing functionality according to particular needs, desires, or particular implementations of the computer (1102), particularly with respect to functionality described in this disclosure. For example, application (1107) can serve as one or more components, modules, applications, etc. Further, although illustrated as a single application (1107), the application (1107) may be implemented as multiple applications (1107) on the computer (1102). In addition, although illustrated as integral to the computer (1102), in alternative implementations, the application (1107) can be external to the computer (1102).

Each of the components of the computer (1102) can communicate using a system bus (1103). In some implementations, any or all of the components of the computer (1102), both hardware or software (or a combination of hardware and software), may interface with each other or the interface (1104) (or a combination of both) over the system bus (1103) using an application programming interface (API) (1112) or a service layer (1113) or a combination of the API (1112) and service layer (1113). The API (1112) may include specifications for routines, data structures, and object classes. The API (1112) may be either computer-language independent or dependent and refer to a complete interface, a single function, or even a set of APIs.

The service layer (1113) provides software services to the computer (1102) or other components (whether illustrated or not) that are communicably coupled to the computer (1102). The functionality of the computer (1102) may be accessible for all service consumers using this service layer. Software services, such as those provided by the service layer (1113), provide reusable, defined business functionalities through a defined interface. For example, the interface may be software written in JAVA, C++, or other suitable language providing data in extensible markup language (XML) format or another suitable format. While illustrated as an integrated component of the computer (1102), alternative implementations may illustrate the API (1112) or the service layer (1113) as stand-alone components in relation to other components of the computer (1102) or other components (whether or not illustrated) that are communicably coupled to the computer (1102). Moreover, any or all parts of the API (1112) or the service layer (1113) may be implemented as child or sub-modules of another software module, enterprise application, or hardware module without departing from the scope of this disclosure.

There may be any number of computers (1102) associated with, or external to, a computer system containing computer (1102), wherein each computer (1102) communicates over network (1130). For example, one computer system may be specifically configured for seismic processing and denoted the seismic processing system (806). Another computer system may be specifically configured for seismic interpretation and denoted the seismic interpretation workstation (808). In some embodiments, seismic processing, such as steps 502-510 of FIG. 5, may be conducted using a first computer (1102) configured as a seismic processor with one or more seismic processing applications (1107) while seismic interpretation, such as step 512 of FIG. 5, may be conducted on a second computer (1102) configured as a seismic interpretation workstation using one or more seismic interpretation applications (1107).

Further, the term “client,” “user,” and other appropriate terminology may be used interchangeably as appropriate without departing from the scope of this disclosure. Moreover, this disclosure contemplates that many users may use one computer (1102), or that one user may use multiple computers (1102).

The final step in determining Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for determining an internal multiples-free seismic dataset, comprising:
obtaining a seismic dataset, wherein the seismic dataset comprises a plurality of space-time gathers;
determining a first truncation operator, wherein the first truncation operator mutes samples of each trace after a first predetermined intercept time in a transform domain;
determining a second truncation operator, wherein the second truncation operator mutes samples of each trace before a second predetermined intercept time in the transform domain; and
applying Marchenko internal multiple attenuation on the seismic dataset using the first and second truncation operators to determine the internal multiples-free seismic dataset.

2. The method of claim 1, further comprising, forming, using a seismic processor, a seismic image based, at least in part, on the internal multiples-free seismic dataset.

3. The method of claim 2, further comprising, determining, using a seismic interpretation workstation, a drilling target within a hydrocarbon reservoir based on the seismic image.

4. The method of claim 2, further comprising:
planning, using a well planning system, a planned wellbore trajectory; and
drilling, using a drilling system, a wellbore guided by the planned wellbore trajectory.

5. The method of claim 1, wherein the seismic dataset comprises a calibrated seismic dataset.

6. The method of claim 1, wherein the first truncation operator comprises:
determining a transformed gather, wherein the transformed gather comprises a seismic trace for each of a plurality of ray-parameters, by transforming the space-time gather from a space-time domain to an intercept-time-ray-parameter (“τ-p”) domain using a τ-p transform;
determining a muted gather by muting each trace of the transformed gather based on a first predetermined intercept time; and
inverting the muted gather using an inverse τ-p transform.

7. The method of claim 1, wherein the second truncation operator comprises:
determining a transformed gather, wherein the transformed gather comprises a seismic trace for each of a plurality of ray-parameters, by transforming the space-time gather from a space-time domain to an intercept-time-ray-parameter (“τ-p”) domain using a τ-p transform;
determining a muted gather by muting the transformed gather based on a second predetermined intercept time; and
inverting the muted gather using an inverse τ-p transform.

8. The method of claim 6, wherein determining the muted gather further comprises muting at least one trace based on a ray-parameter value of the trace in the τ-p domain.

9. A non-transitory computer readable memory having computer-executable instructions stored thereon that, when executed by a processor, perform steps comprising:
obtaining a seismic dataset, wherein the seismic dataset comprises a plurality of space-time gathers;
determining a first truncation operator, wherein the first truncation operator mutes samples of each trace after a first predetermined intercept time in a transform domain;
determining a second truncation operator, wherein the second truncation operator mutes samples of each trace before a second predetermined intercept time in the transform domain; and
applying Marchenko internal multiple attenuation on the seismic dataset using the first and second truncation operators to determine an internal multiples-free seismic dataset.

10. The non-transitory computer readable memory of claim 9, wherein the steps further comprise forming a seismic image based, at least in part, on the internal multiples-free seismic dataset.

11. The non-transitory computer readable memory of claim 9, wherein the first truncation operator comprises:
determining a transformed gather, wherein the transformed gather comprises a seismic trace for each of a plurality of ray-parameters, by transforming the space-time gather from a space-time domain to an intercept-time-ray-parameter (“τ-p”) domain using a τ-p transform;
determining a muted gather by muting each trace of the transformed gather based on a first predetermined intercept time; and
inverting the muted gather using an inverse τ-p transform.

12. The non-transitory computer readable memory of claim 9, wherein the second truncation operator comprises:
determining a transformed gather, wherein the transformed gather comprises a seismic trace for each of a plurality of ray-parameters, by transforming the space-time gather from a space-time domain to an intercept-time-ray-parameter (“τ-p”) domain using a τ-p transform;
determining a muted gather by muting the transformed gather based on a second predetermined intercept time; and
inverting the muted gather using an inverse τ-p transform.

13. The non-transitory computer readable memory of claim 10 wherein determining the muted gather further comprises muting at least one trace based on a ray-parameter value of the trace in the τ-p domain.

14. A system, comprising:
a seismic acquisition system configured to obtain a seismic dataset, wherein the seismic dataset comprises a plurality of space-time gathers; and
a seismic processing system configured to:
determine a first truncation operator, wherein the first truncation operator mutes samples of each trace after a first predetermined intercept time in a transform domain,
determine a second truncation operator, wherein the second truncation operator mutes samples of each trace before a second predetermined intercept time in the transform domain, and
apply Marchenko internal multiple attenuation to the seismic dataset using the first and second truncation operators to determine an internal multiples-free seismic dataset.

15. The system of claim 14, wherein the seismic processing system is further configured to form a seismic image based, at least in part on the internal multiples-free seismic dataset.

16. The system of claim 15, further comprising a seismic interpretation workstation configured to determine a drilling target within a hydrocarbon reservoir based on the seismic image.

17. The system of claim 14, further comprising:
a well planning system, configured to plan a planned wellbore trajectory; and
a drilling system, configured to drill a wellbore guided by the planned wellbore trajectory.

18. The system of claim 14, wherein the first truncation operator comprises:
determining a transformed gather, wherein the transformed gather comprises a seismic trace for each of a plurality of ray-parameters, by transforming the space-time gather from a space-time domain to an intercept-time-ray-parameter (“τ-p”) domain using a τ-p transform;
determining a muted gather by muting each trace of the transformed gather based on a first predetermined intercept time; and
inverting the muted gather using an inverse τ-p transform.

19. The system of claim 14, wherein the second truncation operator comprises:
determining a transformed gather, wherein the transformed gather comprises a seismic trace for each of a plurality of ray-parameters, by transforming the space-time gather from a space-time domain to an intercept-time-ray-parameter (“τ-p”) domain using a τ-p transform;
determining a muted gather by muting the transformed gather based on a second predetermined intercept time; and
inverting the muted gather using an inverse τ-p transform.

20. The system of claim 18, wherein determining a muted gather further comprises muting at least one trace based on a ray-parameter value of the trace.
